(19) United States
(12) Patent Application Publication
(10) Pub. No.: US 2014/0048528 A1
(43) Pub. Date: Feb. 20, 2014

(54) ENERGY EFFICIENT HEATING PAD FOR FOOD PAN ASSEMBLY

(71) Applicant: THE DELFIELD COMPANY LLC, Mt. Pleasant, MI (US)

(72) Inventors: Nicholas L. Reihl, Alma, MI (US); Wayne W. Smith, Mt. Pleasant, MI (US)

(73) Assignee: THE DELFIELD COMPANY LLC, Mt. Pleasant, MI (US)

(21) Appl. No.: 13/760,830

(22) Filed: Feb. 6, 2013

Related U.S. Application Data
(60) Provisional application No. 61/691,236, filed on Aug. 20, 2012.

(51) Int. Cl. F27D 5/00

(52) U.S. Cl. CPC F27D 5/0068
USPC 219/438

(57) ABSTRACT

The food pan assembly of the present disclosure includes a food pan with a well for storing food, and two separate heating pads for supplying heat to food that may be placed in the pan. The heating pads are connected to an exterior side of the pan on a bottom and side surfaces. This allows for improved flexibility in heating options over what is currently available. The heating pads can be independently powered and controlled, according to specific demands for the food to be heated.

### CROSS-REFERENCE TO RELATED APPLICATIONS

The present application claims priority to U.S. Provisional Patent Application No. 61/691,236, filed on Aug. 20, 2012, and which is herein incorporated by reference.

### BACKGROUND OF THE DISCLOSURE

1. Field of the Disclosure

The present disclosure relates to heating pads for food pans. More particularly, the present disclosure relates to heating pads for food pans, where the heating pads are split up into two parts for placement on different areas of the food pan.

2. Description of the Related Art

In food display units, food pans are used to store either dry or wet food, and to either chill or heat the food. To heat the food, current devices use a heat pad located at or welded onto the bottom of the pan. These heating pads produce a high amount of heat, which can result in uneven heating of the food product in the pan, and/or burning the food at the bottom of the pan. Alternatively, some devices use a hot water bath to heat all sides of the food pan. However, this can be an unwieldy design, since it requires filling large basins with water, and then disposing of the water afterward.

Accordingly, there is a need for a device that addresses these disadvantages of current designs.

### SUMMARY OF THE DISCLOSURE

The present disclosure provides a food pan, wherein the food pan has a first heating pad connected to a bottom surface of the food pan, and a second heating pad connected to an exterior surface of the food pan, around the sides of the pan. The first and second heating pads can be removably or permanently connected. The first and second heating pads may also be separately controlled to operate at the same or different times.

### BRIEF DESCRIPTION OF THE DRAWINGS

FIG. 1 shows a first side view of the food pan and heating pads of the present disclosure;

FIG. 2 shows a bottom view of the food pan and heating pads of FIG. 1;

FIG. 3 shows a second side view of food pan and heating pads of FIG. 1; and

FIG. 4 shows a bottom, perspective view of the food pan and heating pads of FIG. 1.

### DETAILED DESCRIPTION OF THE DISCLOSURE

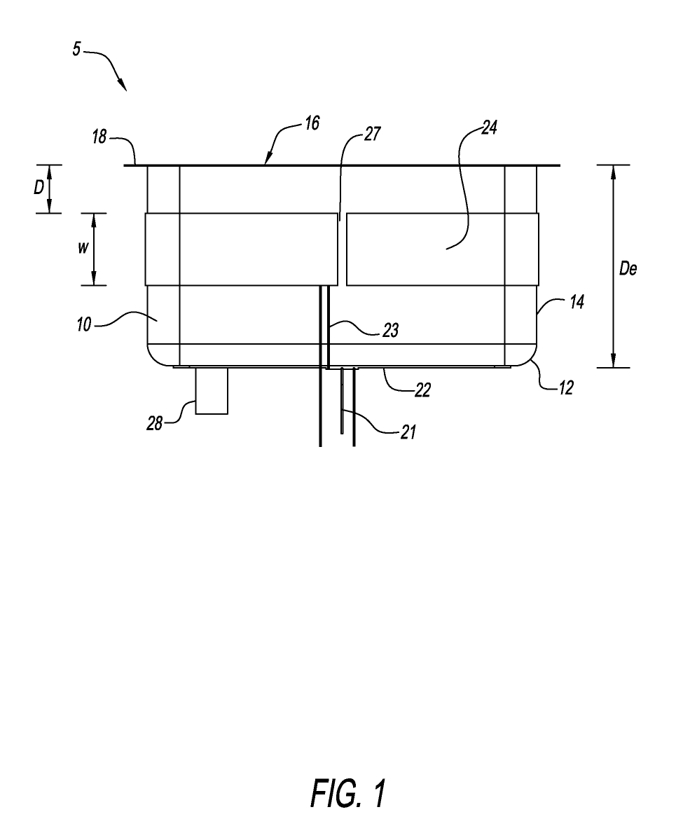

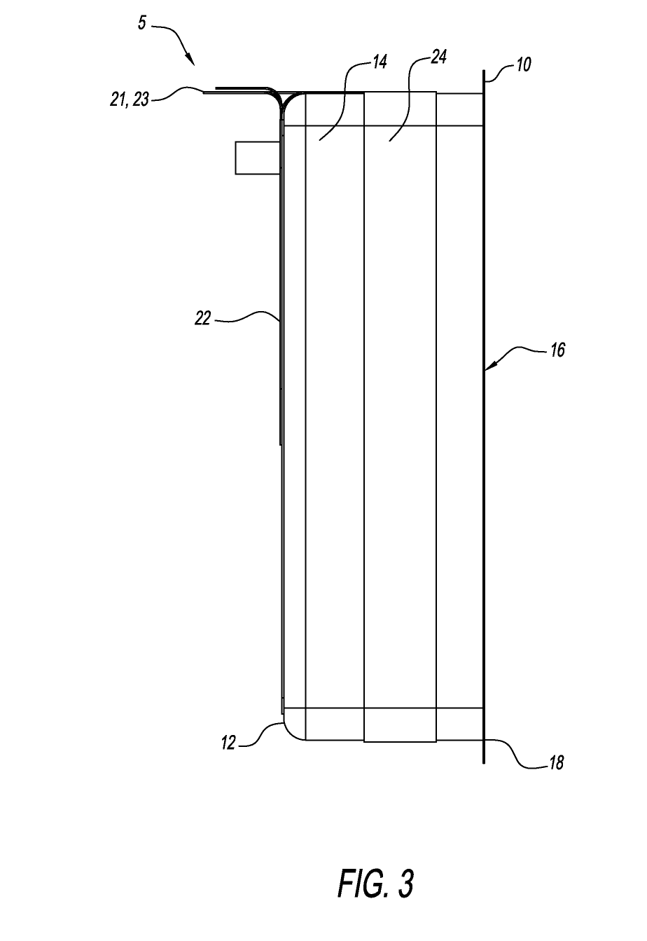

Referring to FIGS. 1-4, assembly 5 of the present disclosure is shown. Assembly 5 includes food pan 10, which in turn includes bottom surface 12, four walls 14, well 16, and top surface 18. When in use, food is placed into well 16 and heated in the manner described below. Walls 14 can be referred to as “front”, “back”, “left,” and “right”, but these terms are used only for ease of description, and do not impart any particular orientation on pan 10. In the description of food pan 10 below, an “exterior” surface or side of pan 10 refers to the sides of walls 14 that are opposite the interior of pan 10. When assembly 5 is in use, food is stored in the interior of pan 10, in well 16.

As shown, food pan 10 has a first or bottom heating pad 22 attached to bottom surface 12, and a second or lateral heating pad 24 attached to an exterior side of walls 14, so that it wraps around all four of walls 14. In the shown embodiment there is one lateral heating pad 24 attached to the exterior side of walls 14. The present disclosure contemplates that there may be one, two, or more lateral heating pads 24 that wrap around the exterior side of walls 14, in parallel spaced arrangement. For example, in one embodiment of food pan 10 there are two lateral heating pads that wrap around the exterior side of walls 14.

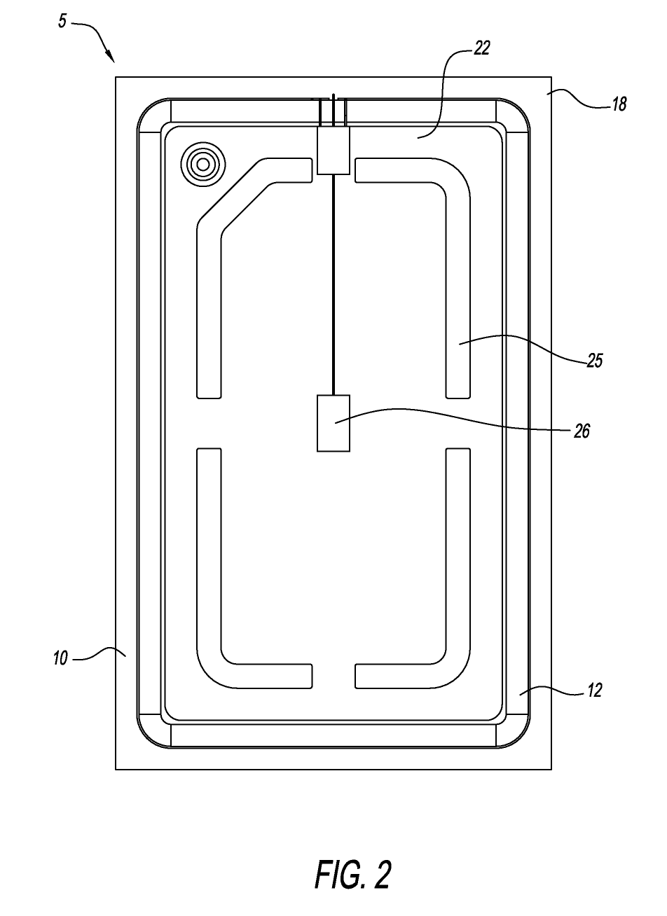

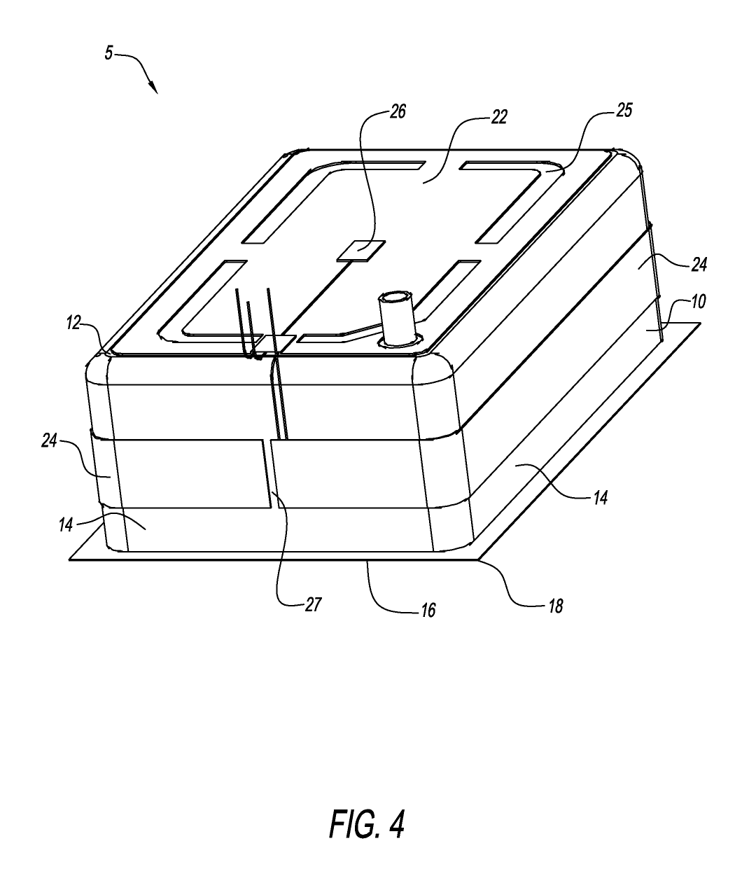

As shown in FIGS. 2 and 4, bottom heating pad 22 can have one or more cutouts 25 thereon. In some embodiments, bottom surface 12 of pan 10 will have one or more embossments (not shown). Cutouts 25 can generally correspond to these embossments, and can be useful in the case where the embossments may cause some separation between bottom surface 12 and bottom heating pad 22. They are not required. Bottom heating pad 22 may also have one or more temperature probes 26 thereon for measuring the temperature of pad 22 and/or bottom surface 12.

As shown in FIGS. 1 and 4, in one embodiment lateral heating pad 24 may not reach completely around the perimeter of walls 14. There may be a small gap 27 as shown. This can be helpful to provide some tolerance in the manufacture of pad 24, and also to prevent any overlap in ends of pad 24, which could lead to burnouts of pad 24.

Food pan 10 provides significant advantages over current pans. The heating of the food within pan 10 is more uniform because of the heating that takes place at both the bottom and on the sides of pan 10. Although attaching separate pads in different locations on pan 10 can involve a more complicated or expensive set up than currently available devices, the benefits provided by the arrangement of pads in the present disclosure is highly advantageous.

A control system (not shown) can be in electrical communication with and distribute power to heating pads 22 and 24 through leads 21 and 23 respectively, in a proportion desired by the user or for a particular application. This provides a level of control over heating the food in pan 10 not found in current devices. Power can be evenly distributed to each of heating pads 22 and 24, or more power can be supplied to either. Each of bottom heating pad 22 and lateral heating pad 24 may be controlled separately, so that they can be activated at the same time, or at different times. Pads 22 and 24 can be controlled so that they are either on or off, or the amount of power supplied to either can be adjustable.

Heating pads 22 and 24 are preferably permanently connected to bottom surface 12 and walls 14. In one embodiment, bottom pad 22 is vulcanized so that it is permanently connected to pan 10. Lateral pads 24 can be attached to walls 24 with a pressure-sensitive adhesive. In another embodiment, pads 22 and 24 are each vulcanized to be permanently connected to pan 10. By “permanent” connection, it is meant that the two cannot be separated without destroying any of pan 10, or pads 22 and 24. Vulcanizing either or both of pads 22 and 24 to connect them to pan 10 ensures a tight connection therebetween, minimizing heat loss. In certain applications, however, it may be difficult to vulcanize both of pads 22 and 24 during manufacturing of assembly 5. Each of bottom heating pad 22 and lateral heating pad 24 can also be removably connected to bottom surface 12 and walls 14, respectively. Pads 22 and 24 are made of a silicone material. Pan 10 is made of a material suitable for contact with food, such as stainless steel.

Lateral heating pad 24 can be rectangularly shaped, so that it is a strip that covers an entire length of the exterior side of wall 14 they are connected to. Lateral heating pad 24 can also have a width W, and can be connected to the exterior side of walls 14 so that a top edge of lateral heating pad 24 is located a distance D from top surface 18 of pan 10. In one embodiment, width W is from one to five inches, or any subranges therebetween. In embodiments where two lateral heating pads 24 are used, each pad can have the same widths W, or they can have different widths W. Distance D is at least one inch. Pan 10, and thus well 16, can have an overall depth De that can be approximately six and one-quarter inches, which is a standard size for food pans. Width W, distance D, and depth De may vary depending on the application where food pan 10 is used.

Pan 10 may also have a drain 28 that extends from bottom surface 12. Drain 28 allows for removal of liquid within well 16. This is useful for when liquid or semi-solid food products, or liquids (e.g., water) are stored in well 16.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

What is claimed is:

1. A food pan assembly, comprising:
a food pan comprising four vertical walls and a horizontal bottom surface that define a well in an interior space of said food pan, wherein said bottom surface has a bottom exterior side that is opposite said well, and said four vertical walls define a lateral exterior side that is opposite said well;
a first heating pad connected to said bottom exterior side; and
a second heating pad connected said lateral exterior side.

2. The assembly of claim 1, wherein said first heating pad and said second heating pad are made of silicone.

3. The assembly of claim 2, wherein said first heating pad and said second heating pad is vulcanized, so that it is permanently connected to said bottom exterior side.

4. The assembly of claim 1, wherein said second heating pad is adhesively and permanently connected to said lateral exterior side.

5. The assembly of claim 1, wherein said second heating pad is a rectangularly-shaped heating pad that wraps around said exterior surface of each of said four surrounding walls.

6. The assembly of claim 1, further comprising a third heating pad connected to said exterior side of said four surrounding walls.

7. The assembly of claim 5, further comprising a third heating pad connected to said exterior side of said four surrounding walls, in spaced relation to said second heating pad.

8. The assembly of claim 7, wherein said second heating pad is a rectangularly-shaped heating pad that wraps around said exterior surface of each of said four surrounding walls

9. The assembly of claim 1, further comprising a control system in electrical communication with said first heating pad and said second heating pad.

10. A method of heating food in a food pan assembly, wherein said food pan assembly comprises:
a food pan comprising a horizontal bottom surface and four vertical walls;
a first heating pad connected to an exterior surface of said bottom surface; and
a second heating pad connected to an exterior surface of said four vertical walls,
the method comprising the steps of:
controlling an amount of power supplied to each of said first heating pad and said second heating pad, to provide heat to food within said food pan.

11. The method of claim 10, wherein said food pan assembly further comprises a third heating pad connected to said exterior surface of said four vertical walls, and said controlling step further comprises controlling an amount of power supplied to said third heating pad.

12. The method of claim 10, further comprising the step of varying said amount of power supplied to said first heating pad and said second heating pad, based on a demand required by said food in said food pan.

13. The method of claim 10, wherein said controlling step comprises supplying said power to said first heating pad and said second heating pad independently of one another.
